(19) United States
(12) Patent Application Publication
(10) Pub. No.: US 2025/0296265 A1
(43) Pub. Date: Sep. 25, 2025

(54) METHOD OF PRODUCING RESIN BOARD INCLUDING PLANT FIBERS

(71) Applicant: TOYOTA BOSHOKU KABUSHIKI KAISHA, Aichi-ken (JP)

(72) Inventor: Kazuo MAEHARA, Aichi-ken (JP)

(73) Assignee: TOYOTA BOSHOKU KABUSHIKI KAISHA, Aichi-ken (JP)

(21) Appl. No.: 19/027,942

(22) Filed: Jan. 17, 2025

(30) Foreign Application Priority Data
Mar. 21, 2024 (JP) 2024-044999

(51) Int. Cl. B27N 5/00; B27N 1/00; B27N 3/04

(52) U.S. Cl. CPC B27N 5/00; B27N 1/00; B27N 3/04

(57) ABSTRACT

A method of producing a resin board including plant fibers includes spreading a plant fiber tow in a planar shape such that plant fibers of the plant fiber tow have similar orientations and obtaining a fiber base member, impregnating the fiber base member with thermoplastic resin, curing the fiber base member impregnated with the thermoplastic resin and binding the plant fibers included in the fiber base member with the thermoplastic resin and obtaining a resin sheet including fibers, cutting the resin sheet including fibers into pieces and obtaining resin pieces including fibers, arranging the resin pieces including fibers in a planar shape to overlap each other and obtaining a multilayered member, and heating and pressing the multilayered member and binding the resin pieces including fibers together as one component and molding into a predefined shape.

### CROSS REFERENCE TO RELATED APPLICATION

This application claims priority from Japanese Patent Application No. 2024-44999 filed on Mar. 21, 2024. The entire contents of the priority application are incorporated herein by reference.

### TECHNICAL FIELD

The present disclosure relates to a method of producing a resin board including plant fibers.

### BACKGROUND

There has been known a method of producing a board member with using plant fibers. In one example of such a method, kenaf is loosened and cut in short pieces to obtain kenaf fibers. The kenaf fibers and short PP resin fibers are mixed with a mixer and molded into a mat by a former. Then, the mat is compressed to have a desired thickness with a pressing machine and cut to be in a desired size. Thus, the thermosetting fiber board is obtained.

### SUMMARY

With the above method, the resin board with a desired rigidity under low amount of mass weight can be obtained and the resin board is also easy to be handled. However, there have been demands of reducing a cost and simplifying the producing method.

An object of the present technology described herein is to provide a method of producing a resin board including plant fibers with which a raw material cost and an equipment cost can be reduced and a resin board including plant fibers is produced easily and simply.

The technology described herein is related to a method of producing a resin board including plant fibers and the method includes spreading a plant fiber tow in a planar shape such that plant fibers of the plant fiber tow have similar orientations and obtaining a fiber base member, impregnating the fiber base member with thermoplastic resin, curing the fiber base member impregnated with the thermoplastic resin and binding the plant fibers included in the fiber base member with the thermoplastic resin and obtaining a resin sheet including fibers, cutting the resin sheet including fibers into pieces and obtaining resin pieces including fibers, arranging the resin pieces including fibers in a planar shape to overlap each other and obtaining a multilayered member, and heating and pressing the multilayered member and binding the resin pieces including fibers together as one component and molding into a predefined shape.

### BRIEF DESCRIPTION OF THE DRAWINGS

FIG. 1 is a perspective view illustrating a trim board according to a first embodiment.

FIG. 2A is a perspective view of a kenaf fiber tow.

FIG. 2B is a perspective view of a fiber base member (a spread process).

FIG. 3 is an enlarged schematic view illustrating a portion of the kenaf fibers included in the fiber base member.

FIG. 4A is a perspective view illustrating the fiber base member on which a polypropylene film is disposed (a resin sheet including fibers forming process).

FIG. 4B is a perspective view of a resin sheet including fibers.

FIG. 5 is a perspective view illustrating the resin sheet including fibers in a cutting process.

FIG. 6 is a plan view of a multilayered member (a multilayered member forming process).

FIG. 7 is a side view illustrating a preboard that is arranged in a molding die (a heat press molding process).

FIG. 8 is an elevation view of a base board (a trim board).

FIG. 9A is a plan view of a multilayered member according to a second embodiment (the multilayered member forming process).

FIG. 9B is an elevation view of a base board (a trim board).

FIG. 10A is a plan view of a multilayered member according to a third embodiment (the multilayered member forming process).

FIG. 10B is an elevation view of a base board (a trim board).

### DETAILED DESCRIPTION

### First Embodiment

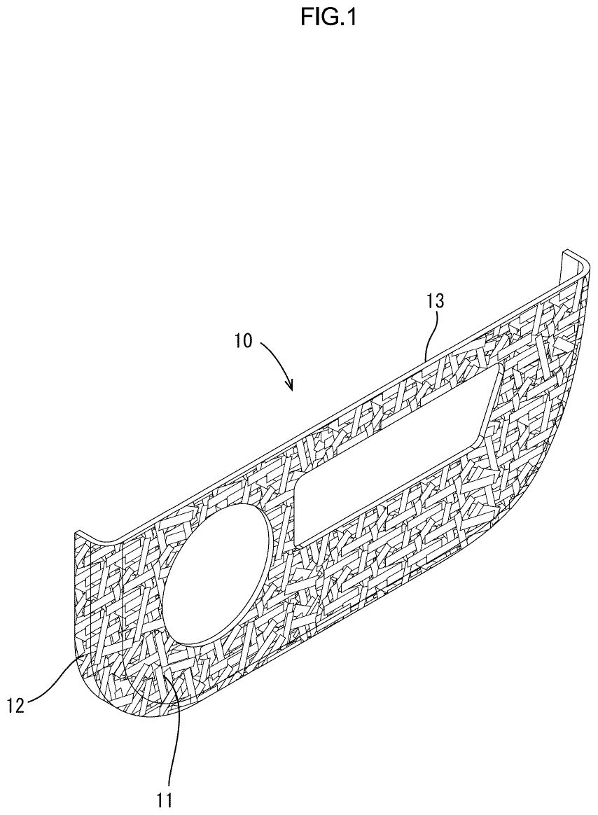

A first embodiment will be described with reference to FIGS. 1 to 8. A base board 13 (a trim board 10) for a vehicle is described as one example of a resin board including plant fibers. The trim board 10 is configured as a portion of a door trim that is mounted on a door panel of a door for a vehicle such as an automobile. The door trim is mounted on a vehicular interior side of the door panel. The trim board 10 has a surface that is configured as an interior wall surface of a vehicular compartment and the trim board 10 is as an interior component for improving an appearance and comfort of the vehicular interior space. As illustrated in FIG. 1, the trim board 10 includes a flat portion 11 that is a flat plate and a wall portion 12 that extends vertically from edges of the flat portion 11. The trim board 10 includes a base board 13 as a main component and may further include a skin that covers a vehicular interior side surface of the base board 13. The base board 13 is made of plant fibers and thermoplastic resin.

The plant fibers are fibers of natural plants. Examples of plant fibers may include fibers of kenaf, flax, hemp, jute, Manila hemp, sisal hemp, Diplomorpha sikokiana, Edgeworthia chrysantha, Broussonetia×kazinoki, banana, pineapple, Cocos nucifera, corn, sugar cane, bagasse, palm, papyrus, reed, esparto, Sabai grass, oat, rice plant, bamboo, coniferous tree (such as Japanese cedar, Hinoki cypress), Broad-leaved tree, and cotton. Parts of the plants used for the plant fibers are not specified as long as fibers can be obtained. Any parts of the plants such as non-wood parts, stalks, roots, leaves, and wood parts may be used.

The plant fibers are obtained by retting the plant described above. Specifically, the plant fibers are obtained as follows. First, the plant is immersed in water to break down the binding components contained in the plant (pectin that binds the plant fibers of the plant) using the power of aquatic microorganisms and enzyme and remove the portions other than the plant fibers. With such a retting process, the plant fibers are not completely separated from each other but the binding of the plant fibers is weakened. Accordingly, a plant fiber tow that can be easily loosened is obtained.

An average length of the plant fibers included in the plant fiber tow obtained as described above is not particularly limited but may be preferably from 500 mm to 4,000 mm. An average diameter of the plant fiber tow is preferably from 10 mm to 20 mm. An average diameter of each plant fiber is preferably from 50 μm to 150 μm and more preferably from 80 μm to 100 μm.

Kenaf fibers are preferably used as the plant fibers. Kenaf is an annual plant that grows fast and has good ability to absorb carbon dioxide. Therefore, carbon dioxide in the air is reduced and forest resource can be utilized by using kenaf. Bast plant fibers such as kenaf are preferable in reducing weight since the fibers include spaces. In this embodiment, kenaf fiber whose average fiber diameter is 80 μm to 100 μm are used as the plant fiber.

The thermoplastic resin is included in the base board 13 of the trim board 10 as binder resin and various kinds of thermoplastic resin may be used. Examples of thermoplastic resin may include polyolefin resin, polyester resin, polystyrene, acrylic resin (resin including methacrylate or acrylate, resin including methacrylate and acrylate), polyamide resin, polycarbonate resin, polyacetal resin, and ABS resin. Examples of polyolefin resin include polypropylene, polyethylene, and ethylene-propylene copolymer (ethylene-propylene block copolymer, ethylene-propylene random copolymer). Examples of polyester resin include polylactic acid, aliphatic polyester resin such as polycaprolactone and polybutylene succinate, aromatic polyester such as polyethylene terephthalate, polytrimethylene terephthalate, and polybutylene terephthalate. One kind or two or more kinds of the above examples of thermoplastic resin may be used. In this embodiment, polypropylene is used as the thermoplastic resin.

The base board 13 of the trim board 10 includes groups of kenaf fibers, which will be referred to as kenaf fiber groups, each of which includes kenaf fibers 21. The kenaf fibers 21 included in one kenaf group have a same fiber orientation. The fiber orientations of the kenaf fibers 21 are defined as an orientation direction. The kenaf fibers 21 extend substantially along the fiber orientation. In each kenaf group, kenaf fibers are arranged in a crossing direction crossing the orientation direction. More in detail, in each kenaf group, kenaf fibers having a length from 10 mm to 100 mm are arranged laterally (in the crossing direction) so as to spread along a surface of the base board 13 with a same fiber orientation. The kenaf fiber groups are arranged to spread in a planar direction and overlap each other in the thickness direction of the base board 13. The kenaf fiber groups are arranged at random such that orientations of the kenaf fibers in the adjacent kenaf fiber groups do not match. The kenaf fibers in the adjacent kenaf fiber groups have different orientations. Even with some of the kenaf fibers in one kenaf fiber group having different orientations, the fiber orientations of the one kenaf group are regarded as one.

In the trim board 10 of this embodiment, the content (mass %) of the kenaf fibers 21 is 35 mass % or more and preferably 40 mass % or more, and 80 mass % or less and preferably 50 mass % or less. With the content of the kenaf fibers being in such a range, the trim board 10 is reduced in weight and increased in rigidity and easily obtains shock resistance.

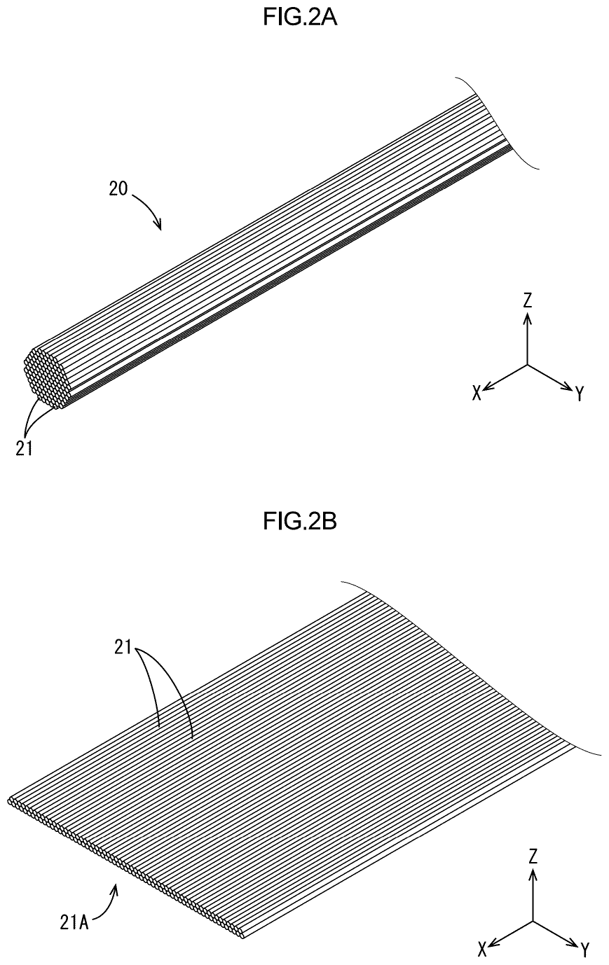

Next, a method of producing the base board 13 (the trim board 10) will be described. The base board 13 (the trim board 10) of this embodiment is produced with using a long kenaf fiber tow 20 as illustrated in FIG. 2A. The kenaf fiber tow 20 is obtained with the retting process in which kenaf is immersed in water to separate bark and bast using the power of aquatic microorganisms and obtaining kenaf fibers from the bast.

### <Spread Process>

The kenaf fiber tow 20 (one example of a plant fiber tow) illustrated in FIG. 2A is obtained from kenaf and has a circular columnar shape. As illustrated in FIG. 2B, the kenaf fiber tow 20 is spread in a planar shape with being loosened in a lateral direction (the crossing direction, the Y-direction) that crosses an extending direction (the X-direction, the orientation direction) in which the kenaf fiber tow 20 extends. As illustrated in FIG. 2B, with the kenaf fiber tow 20 being spread in a planar shape, a fiber base member 21A having a plate shape is obtained. The orientations of the kenaf fibers 21 included in the fiber base member 21A substantially correspond to the extending direction in which the kenaf fiber tow 20 extends.

With the kenaf fibers 21 included in the fiber base member 21A being arranged in a planar shape, the kenaf fibers 21 are arranged laterally or arranged in the crossing direction crossing the extending direction in which the kenaf fibers 21 extend. All the kenaf fibers 21 may not be necessarily arranged laterally. Some of the kenaf fibers 21 may be overlapped with each other in the upper-bottom direction (the Z-direction) and the kenaf fibers 21 are arranged in a planar shape as a whole.

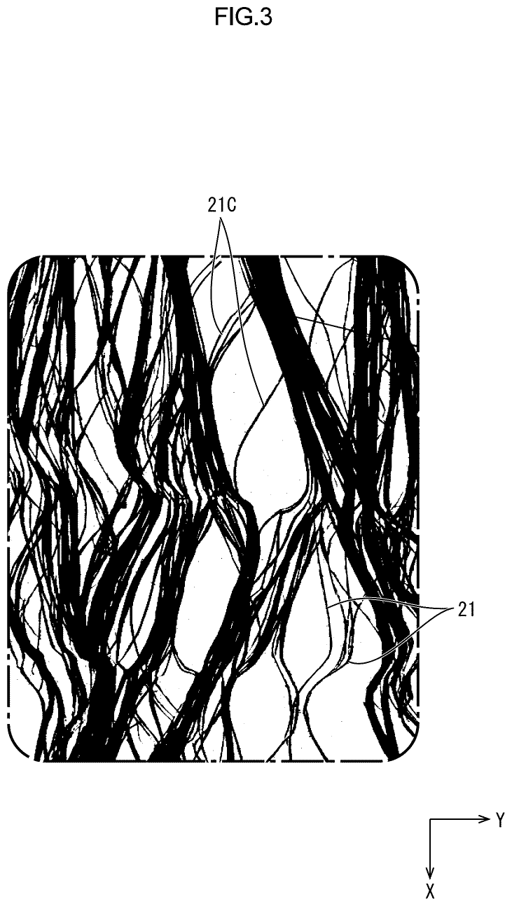

FIG. 3 is an enlarged plan view schematically illustrating a portion of the fiber base member 21A that includes the kenaf fibers 21 planarly arranged. In FIG. 3, lines extending vertically indicate the kenaf fibers 21. The orientations of most of the kenaf fibers 21 are substantially same and correspond to the X-direction or the upper-bottom direction in FIG. 3. Some of the kenaf fibers 21 extend laterally (the direction crossing the X-direction) and are defined as joint fibers 21C. The joint fibers 21C extend between adjacent kenaf fibers 21 and connect them. Namely, some of the kenaf fibers 21 that are laterally arranged are tangled and connected to each other. Some of the kenaf fibers 21 that are adjacent to each other in the direction crossing the extending direction of the kenaf fibers 21 are tangled and connected.

In this embodiment, the kenaf fiber tow 20 before spreading has a length of about 500 mm to 4,000 mm and a diameter of about 10 mm to 20 mm. The fiber base member 21A including the laterally arranged kenaf fibers 21 has a width (a Y-direction dimension) of about 200 mm and a thickness (a Z-direction dimension) of 0.1 mm to 0.3 mm. The width of the fiber base member 21A after spreading (measured in the Y-direction in which the kenaf fibers 21 are laterally arranged) is preferably five times or more of the diameter of the kenaf fiber tow 20 and more preferably ten times or more.

### <Resin Sheet Including Fibers Forming Process>

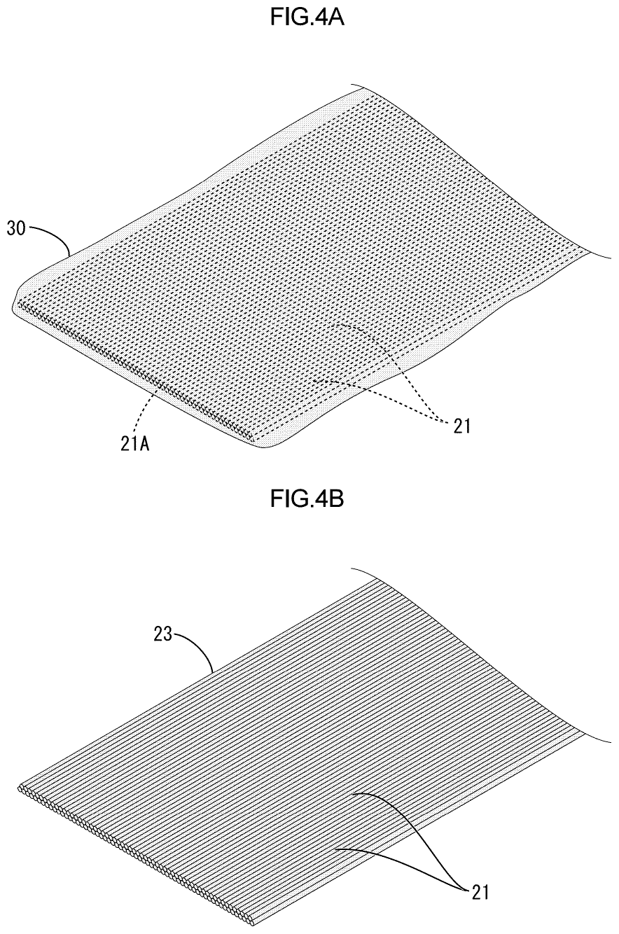

Next, the fiber base member 21A is impregnated with polypropylene, which is one example of thermoplastic resin. As illustrated in FIG. 4A, a polypropylene film 30 that is expanded in a film shape is disposed on the fiber base member 21A. The polypropylene film 30 and the fiber base member 21A that are overlapped are heated such that polypropylene is melted and the kenaf fibers 21 are impregnated with melted polypropylene. During the heating, by pressing the polypropylene film 30 and the fiber base member 21A from the polypropylene film 30 side toward the fiber base member 21A, polypropylene spreads uniformly. Thereafter, polypropylene is cooled and cured and the kenaf fibers 21 are connected to each other with polypropylene resin. Thus, as illustrated in FIG. 4B, a resin sheet including fibers 23 in which the kenaf fibers 21 are bound together with polypropylene resin is obtained.

In this embodiment, the thickness of the polypropylene film 30 is from 0.1 mm to 0.3 mm.

### <Cutting Process>

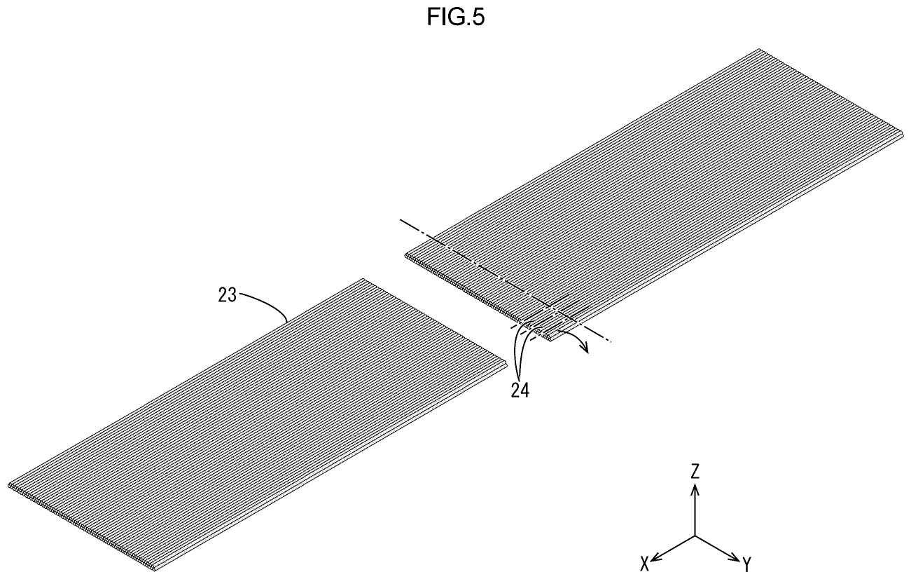

Next, the obtained resin sheet including fibers 23 is cut along the orientation direction (the extending direction in which the kenaf fibers 21 extend, the X-direction in FIG. 5) of the kenaf fibers 21 and along the direction perpendicular to the orientation direction (the Y-direction in FIG. 5, the crossing direction). After cutting, as illustrated in FIG. 5, resin pieces including fibers 24 of a strip shape are obtained. Most of the kenaf fibers 21 included in the resin piece including fibers 24 have an orientation along an elongated direction of the resin piece including fibers 24. However, some of the kenaf fibers 21 (the joint fibers 21C) included in the resin piece including fibers 24 extend in a direction crossing the elongated direction (refer to FIG. 3). The resin piece including fibers 24 has a length dimension of from 5 mm to 100 mm and a width dimension of from 1 mm to 100 mm. The length dimension corresponds to a dimension measured in the orientation direction of the kenaf fibers 21. The width dimension corresponds to a dimension measured in the direction perpendicular to the orientation direction of the kenaf fibers 21.

### <Multilayered Member Forming Process>

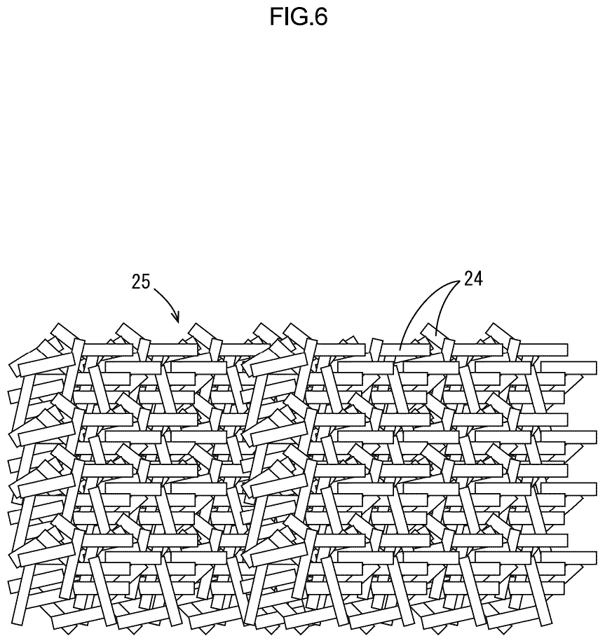

Next, as illustrated in FIG. 6, the obtained resin pieces including fibers 24 are spread in a planar shape and overlapped with each other to obtain a multilayered member 25 having a certain thickness. The resin pieces including fibers 24 are arranged to be overlapped with random fiber orientations. Namely, the resin pieces including fibers 24 are arranged to overlap each other such that the fiber orientations of the kenaf fibers 21 of the adjacent resin pieces including fibers 24 do not match. FIG. 6 is a plan view schematically illustrating the multilayered member 25. The resin pieces including fibers 24 are arranged at random with various orientations.

The multilayered member 25 of this embodiment has a vertical dimension of 1,000 mm, a lateral dimension of 1,500 mm, and a thickness of 50 mm.

### <Preboard Forming Process>

Next, the obtained multilayered member 25 is pressed with heated with a hot plate pressing device or a hot belt pressing device. The multilayered member 25 including the resin pieces including fibers 24 are pressed with being heated or after heated. The heating temperature is set to the melting point of polypropylene (thermoplastic resin) included in the multilayered member 25 or higher. Accordingly, polypropylene included in the multilayered member 25 (the resin pieces including fibers 24) is melted by heating and the adjacent resin pieces including fibers 24 are connected to each other and a preboard 26 having a plane plate shape is obtained. In the obtained preboard 26, the kenaf fibers 21 in the different resin pieces including fibers 24 of the multilayered member 25 are bound together with polypropylene. The preboard 26 is a base substrate before being molded in a product shape of the trim board 10.

### <Heat Press Molding Process>

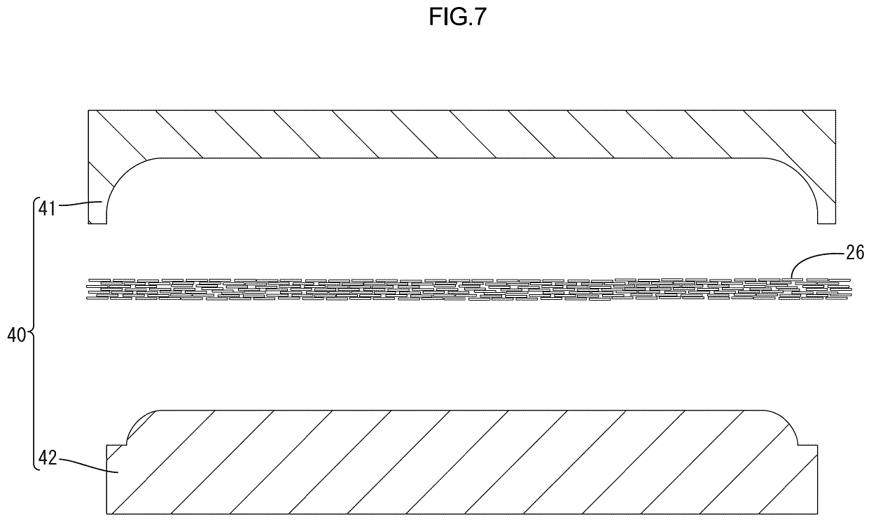

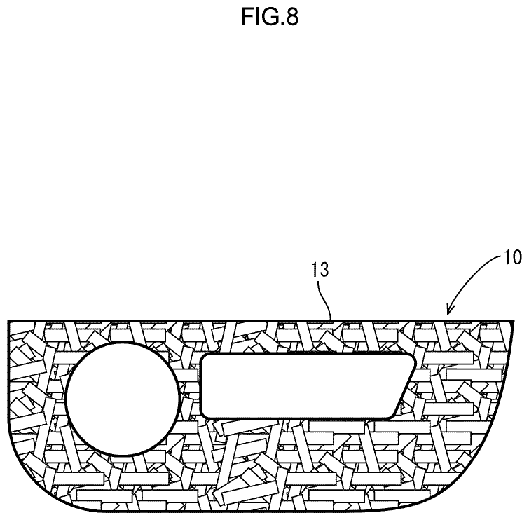

As illustrated in FIG. 7, the preboard 26 is heated and subsequently disposed between an upper die 41 and a lower die 42 of a molding die 40 that is opened. With closing the molding die 40 by relatively moving the upper die 41 and the lower die 42 to be closer, the preboard 26 is press-molded in a predefined shape. Then, after the preboard 26 pressed in the molding die 40 is cooled such that polypropylene is cooled, the molding die 40 is opened and the base board 13 (the trim board 10) is obtained as illustrated in FIG. 8.

As is previously described, the method of producing the base board 13 (the trim board 10) includes the spread process, the resin sheet including fibers forming process, the cutting process, the multilayered member forming process, the preboard forming process, and the heat press molding process. In the spread process, the kenaf fiber tow 20 obtained from kenaf is spread in a planar shape such that orientations of the kenaf fibers 21 are similar.

After the spread process, in the resin sheet including fibers forming process, the kenaf fibers 21 are impregnated with polypropylene (thermoplastic resin) and with polypropylene being cured, the kenaf fibers 21 are bound together with polypropylene and the resin sheet including fibers 23 is formed. In the cutting process, the resin sheet including fibers 23 is cut into resin pieces including fibers 24. In the multilayered member forming process, the resin pieces including fibers 24 are planarly arranged and disposed to overlap each other and the multilayered member 25 is formed. In the heat press molding process, the multilayered member 25 is heated and pressed and the resin pieces including fibers 24 are bound together as one component and molded into a predefined shape. Thus, the base board 13 (the trim board 10) is produced.

In the previously known method of producing a resin board including plant fibers, short plant fibers obtained by cutting and thermoplastic resin fibers are mixed and the mixture is molded into a resin board including plant fibers. On the other hand, with the method of this embodiment, inexpensive pellets or a film of thermoplastic resin can be used instead of the thermoplastic resin that is processed into fibers. Furthermore, a mixer for mixing the plant fibers and the thermoplastic resin fibers and an interlacing device for forming a mat are not necessary with the method of this embodiment. Therefore, a material cost and an equipment cost are reduced. Specifically, supplies such as garnet wires and needle punches are not necessary. Furthermore, compared to the previously known method, with the method of this embodiment, dust or powders are less likely to be generated from the plant fibers and material yield is improved. Thus, the base board 13 (the trim board 10) is easily produced at a low cost.

The base board 13 (the trim board 10) includes long kenaf fibers compared to the board obtained using short fibers with the known method. Therefore, strength and rigidity of the base board 13 (the trim board 10) can be increased and this eventually reduces a weight of the trim board 10.

In the spread process, the kenaf fiber tow 20 is spread in a planar shape such that some of the kenaf fibers 21 that are adjacent to each other in the lateral direction crossing the orientation direction of the kenaf fibers 21 are bound together.

With such a method, unlike a base board obtained by completely loosening the kenaf fiber tow 20 as if loosening with using a comb, the obtained base board 13 (the trim board 10) has increased strength and rigidity with respect to the direction crossing the orientation direction of the kenaf fibers 21. Due to the binding of the kenaf fibers 21, the content of the thermoplastic resin such as polypropylene can be reduced and this reduces a weight of the board.

In the resin sheet including fibers forming process, the polypropylene film 30 disposed on the laterally arranged kenaf fibers 21 is heated such that kenaf fibers 21 are impregnated with polypropylene. With such a producing method, the kenaf fibers 21 are impregnated with polypropylene easily and uniformly in a planar area.

In the cutting process, the resin sheet including fibers 23 is cut along the orientation direction of the kenaf fibers 21 and also cut along the direction crossing the orientation direction of the kenaf fibers 21. In the multilayered member forming process, the resin pieces including fibers 24 are arranged to overlap each other with random fiber orientations. The resin pieces including fibers 24 are arranged to overlap such that the fiber orientations of the kenaf fibers 21 of the adjacent resin pieces including fibers 24 do not match. With such a method, the obtained base board 13 (trim board 10) has uniform weight and uniform strength as a whole.

### Second Embodiment

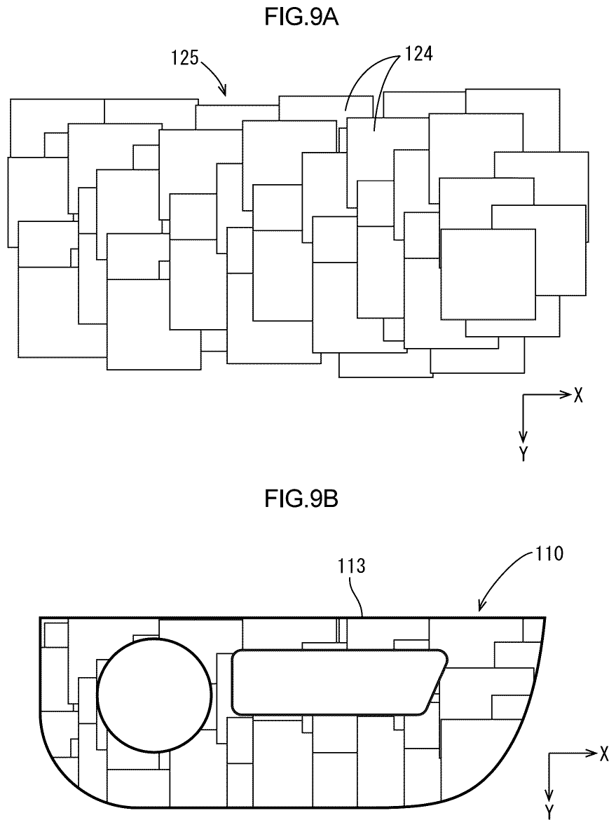

A second embodiment differs from the first embodiment in the shape of cut pieces obtained by cutting the resin sheet including fibers 23. In this embodiment, the resin sheet including fibers 23 is cut into square pieces that are much wider and greater than the strip-shaped pieces of the first embodiment. The components of the second embodiment that are same as those of the above embodiment will not be described. The resin sheet including fibers 23 is cut only along the direction perpendicular to the orientation direction of the kenaf fibers 21 and resin pieces including fibers 124 are obtained. As illustrated in FIG. 9A, the resin pieces including fibers 124 have a square shape. Each side dimension of the resin piece including fibers 124 is same as the width of the resin sheet including fibers 23 (Y-dimension). Namely, the resin piece including fibers 124 has a square shape having a side dimension of about 200 mm. In the resin sheet including fibers forming process, the kenaf fibers 21 that are planarly disposed may have different width on one end portions (root side portions) and other end portions (tip portions). With cutting the resin sheet including fibers 23 including such kenaf fibers 21 only along the direction perpendicular to the orientation direction of the kenaf fibers 21 in the cutting process, the obtained resin pieces including fibers 124 may have a shape of a trapezoid.

As illustrated in FIG. 9A, in the multilayered member forming process, the resin pieces including fibers 124 of a square shape are planarly arranged such that corresponding one of the sides of the resin pieces including fibers 124 extend along the same direction. Thus, a multilayered member 125 is obtained. In the multilayered member 125, some of the resin pieces including fibers 124 include the kenaf fibers 21 that extend in the X-direction in FIG. 9A and some of the resin pieces including fibers 124 include the kenaf fibers 21 that extend in the Y-direction.

A base board 113 (a trim board 110) illustrated in FIG. 9B is obtained by molding the multilayered member 125. Each resin piece including fibers 124 includes more joint fibers 21C than the resin piece including fibers 24 of the first embodiment. Namely, each resin piece including fibers 124 includes more joint portions that connect the kenaf fibers 21 in the lateral direction (the direction crossing the extending direction of the kenaf fibers 21). Therefore, strength and rigidity of the base board 112 (the trim board 110) is increased.

### Third Embodiment

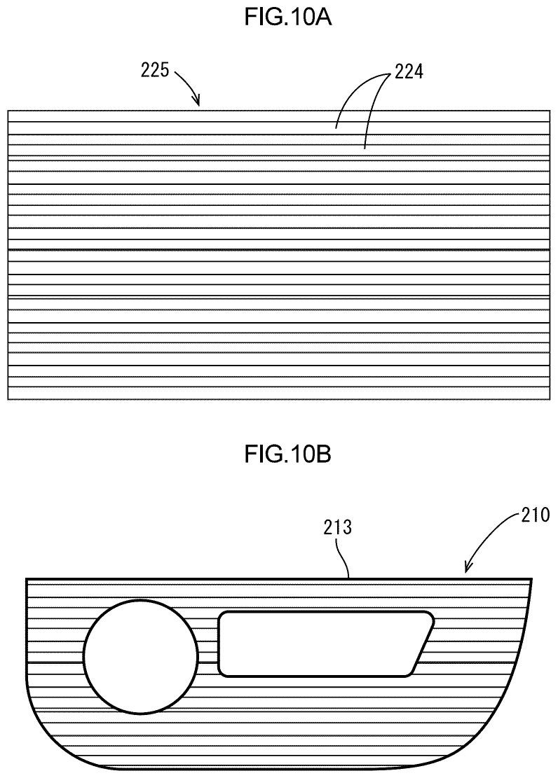

A third embodiment differs from the above embodiments in a cutting process. In the third embodiment, the resin sheet including fibers 23 is cut only along the extending direction in which the kenaf fibers 21 extend and resin pieces including fibers 224 are obtained. As described in FIG. 10A, the resin pieces including fibers 224 have an elongated belt shape.

In the multilayered member processing process, the resin pieces including fibers 224 having an elongated belt shape are planarly arranged and overlapped such that the extending direction in which the kenaf fibers 21 of all the resin pieces including fibers 224 match as illustrated in FIG. 10A. Thus, a multilayered member 225 is obtained. As illustrated in FIG. 10B, a base board 213 (a trim board 210) is obtained by molding the multilayered member 225. The base board 213 has a beautiful design of a wood pattern.

### Other Embodiments

The technology described herein is not limited to the embodiments described above with reference to the drawings. The following embodiments may be included in the technical scope. The technology described herein may be modified within the technical scope.

(1) In the above embodiments, by heating the polypropylene film 30 disposed on the fiber base member 21A that includes the planarly arranged kenaf fibers 21 and melting polypropylene, the kenaf fibers 21 are impregnated with melted polypropylene. However, the method of impregnating plant fibers with thermoplastic resin is not limited to the one described in the above embodiments. For example, plant fibers may be impregnated with thermoplastic resin by melting pellets of thermoplastic resin in a hopper and pushing out the molten resin or spraying molten thermoplastic resin.

(2) When impregnating plant fibers with thermoplastic resin, the thermoplastic resin may not be pressurized.

(3) In the cutting process, the resin sheet including fibers may be cut into pieces of any shapes. In the multilayered member forming process, when the resin pieces including fibers are planarly arranged and overlapped with each other, the orientations of the resin pieces including fibers may be changed from that in the above embodiments.

(4) The preboard forming process may not be included. With such a method, the multilayered member is formed on a support sheet and the multilayered member and the support sheet supporting the multilayered member is arranged in the molding die for performing press molding.

(5) The present technology is not necessarily applied to the base board 13 (the trim board 10) of a vehicular door trim but may be applied to various kinds of resin boards including plant fibers.

1. A method of producing a resin board including plant fibers, the method comprising:
spreading a plant fiber tow in a planar shape such that plant fibers of the plant fiber tow have similar orientations and obtaining a fiber base member;
impregnating the fiber base member with thermoplastic resin;
curing the fiber base member impregnated with the thermoplastic resin and binding the plant fibers included in the fiber base member with the thermoplastic resin and obtaining a resin sheet including fibers;
cutting the resin sheet including fibers into pieces and obtaining resin pieces including fibers;
arranging the resin pieces including fibers in a planar shape to overlap each other and obtaining a multilayered member; and
heating and pressing the multilayered member and binding the resin pieces including fibers together as one component and molding into a predefined shape.

2. The method of producing a resin board including plant fibers according to claim 1, wherein in the spreading, the orientations of the plant fibers correspond to an orientation direction and some of the plant fibers that are adjacent to each other in a crossing direction crossing the orientation direction are connected to each other.

3. The method of producing a resin board including plant fibers substrate according to claim 1, wherein in the impregnating, a resin film of the thermoplastic resin is disposed on the fiber base member and the resin film and the fiber base member are heated and thereby impregnating the fiber base member with the thermoplastic resin.

4. The method of producing a resin board including plant fibers according to claim 1, wherein
in the spreading, the orientations of the plant fibers correspond to an orientation direction,
in the cutting, the resin sheet including fibers is cut into pieces along the orientation direction and a crossing direction crossing the orientation direction, and
in the arranging, the resin pieces including fibers are arranged to overlap each other with random orientations such that the plant fibers of the resin pieces including fibers that are adjacent to each other have different orientations.

5. The method of producing a resin board including plant fibers according to claim 1, wherein
in the spreading, the orientations of the plant fibers correspond to an orientation direction,
in the cutting, the resin sheet including fibers is cut into pieces along the orientation direction, and
in the arranging, the resin pieces including fibers are arranged to overlap each other such that the plant fibers of the resin pieces including fibers have a same orientation.

6. The method of producing a resin board including plant fibers according to claim 1, wherein
in the spreading, the orientations of the plant fibers correspond to an orientation direction,
in the cutting, the resin sheet including fibers is cut into pieces along the orientation direction and a crossing direction crossing the orientation direction, and
in the arranging, the resin pieces including fibers are arranged to overlap each other such that the plant fibers of the resin pieces including fibers that are adjacent to each other have different orientations.

7. The method of producing a resin board including plant fibers according to claim 6, wherein in the cutting, the resin pieces including fibers have a square shape having a side dimension that is same as a width of the resin sheet including fibers.

8. The method of producing a resin board including plant fibers according to claim 2, wherein in the spreading, the plant fibers include joint fibers that connects the some of the plant fibers that are adjacent to each other in the crossing direction.

9. The method of producing a resin board including plant fibers according to claim 4, in the cutting, the resin pieces including fibers have a strip shape.

10. The method of producing a resin board including plant fibers according to claim 9, the resin pieces including fibers have a length of from 5 mm to 10 mm and a width of from 1 mm to 100 mm.
